(19) United States
(12) Patent Application Publication
(10) Pub. No.: US 2026/0212254 A1
(43) Pub. Date: Jul. 23, 2026

(54) FORECASTING MASTER DATA IN A SKEWED DATA SET USING HYBRID MACHINE LEARNING MODELS

(71) Applicant: SAP SE, Walldorf (DE)

(72) Inventor: Aparna Mellihalli, Munich (DE)

(21) Appl. No.: 19/028,070

(22) Filed: Jan. 17, 2025

(51) Int. Cl. G06N 20/00; G06F 16/215

(52) U.S. Cl. CPC G06N 20/00; G06F 16/215

(57) ABSTRACT

Systems and methods described herein relate to hybrid machine learning techniques for forecasting master data, such as scrap data. A hybrid machine learning model includes a first machine learning model (e.g., balanced random forest classifier) that generates a prediction with respect to whether or not a manufacturing process will result in scrap generation. If the first machine learning model predicts that no scrap will be generated in the manufacturing process, then an output prediction is that no scrap will be generated in the manufacturing process. If the first machine learning model predicts that scrap will be generated in the manufacturing process, then a second machine learning model (e.g., gradient boost regressor) predicts a value of scrap percentage. The value of scrap percentage is provided as an output prediction of a percentage of scrap that will be generated in the manufacturing process.

### TECHNICAL FIELD

The subject matter disclosed herein generally relates to database technology. More specifically, but not exclusively, the subject matter relates to forecasting data in skewed or imbalanced data sets using machine learning technologies.

### BACKGROUND

Various industries use database technology for organizing, storing, and analyzing data. As these industries become more technically advanced, the need for advancements in database technology increases. For example, as these industries become more technically advanced, these industries also grow increasingly complex. As a result, there is a need for advancements in database technology to organize, store, and analyze the increasingly complex data used in these industries. This creates various technical challenges in the field of database technology because many existing database technologies fail to efficiently and accurately operate on increasingly complex data.

### BRIEF DESCRIPTION OF THE DRAWINGS

Some examples are shown for purposes of illustration and not limitation in the figures of the accompanying drawings. In the drawings, which are not necessarily drawn to scale, like numerals may describe similar components in different views or examples. It should be understood that additional and alternative examples are possible without departing from the principles of the subject matter described herein.

FIG. 1 diagrammatically illustrates a network environment that includes a master data forecast system, according to some examples.

FIG. 2 is a block diagram of components of a master data forecast system, according to some examples.

FIG. 3 is a block diagram of a neural network suitable for use as a classifier or other machine learning model described herein, according to some examples.

FIG. 4 is a block diagram of a relational database including details of a completed production order, according to some examples.

FIG. 5 is a block diagram of training a hybrid machine learning model, according to some examples.

FIG. 6 is a block diagram of using a hybrid machine learning model, according to some examples.

FIG. 7 is a flowchart of a method for generating a forecast of master data, according to some examples.

FIG. 8 is a block diagram showing a software architecture for a computing device, according to some examples.

FIG. 9 is a block diagram of a machine in the form of a computer system, according to some examples, within which instructions may be executed for causing the machine to perform any one or more of the methodologies discussed herein.

### DETAILED DESCRIPTION

As artificial intelligence (AI) technologies continue to advance, their applications likewise become more widespread, including in database technologies. The application of AI technologies in database technologies is useful, for example, to analyze complex data that cannot readily be analyzed using traditional mathematical models or using manual calculations. For example, scrap (e.g., defective product, unusable material) is an ongoing problem in various manufacturing processes with a wide range of factors contributing to the generation of scrap. Due to this wide range of factors, predicting how much scrap will be generated in a manufacturing process is a complex technical problem that is not readily addressed using a traditional mathematical model or using manual calculations. Accordingly, prediction of scrap in a manufacturing process, as well as other complex predictions, is one example of a technical problem for which application of AI technologies provides a potential technical solution.

The application of AI technologies to database technologies to make complex predictions, such as prediction of scrap in a manufacturing process, poses various technical problems. For example, data related to scrap generation in manufacturing processes are skewed and unbalanced. In general, scrap generation occurs in a relatively small percentage (e.g., 3-5%) of manufacturing processes, and the amount of scrap generated is a relatively small percentage (e.g., 1-5%). Applying a typical machine learning approach to make predictions based on such a skewed and unbalanced data set results in inaccurate predictions. For example, a machine learning model may consistently predict no scrap will be generated for a manufacturing process based on the relatively small percentage at which scrap generation occurs. Thus, application of AI technologies to database technologies to make complex predictions poses various technical problems.

Examples described herein seek to address the aforementioned, as well as other, technical problems arising in the field of database technologies. As an overview, the examples described herein provide for hybrid machine learning techniques for forecasting master data, such as scrap data. A hybrid machine learning model includes a first classifier machine learning model (e.g., balanced random forest classifier) that generates a prediction with respect to whether or not a manufacturing process will result in scrap generation. If the first machine learning model predicts that no scrap will be generated in the manufacturing process, then an output prediction is that no scrap will be generated in the manufacturing process. If the first machine learning model predicts that scrap will be generated in the manufacturing process, then a second regressor machine learning model (e.g., gradient boost regressor) predicts a value of scrap percentage. The value of scrap percentage is provided as an output prediction of a percentage of scrap that will be generated in the manufacturing process. The hybrid machine learning model makes these predictions based on various factors related to the manufacturing process, such as order quantity, duration of operation, materials used, material storage location, manufacturing location, manufacturing tools, and the like. Advantageously, the hybrid machine learning model provides accurate predictions on skewed and unbalanced data sets where other machine learning approaches may fail.

The hybrid machine learning model is trained based on historical data (e.g., confirmation data) combined with master data (e.g., master data related to the production plant, material etc.) related to manufacturing processes and scrap generation. The historical data includes information related to manufacturing processes (e.g., order quantity, duration of operation, materials used, material storage location, manufacturing location, manufacturing tools) and information related to amounts of scrap generated during the manufacturing processes. Based on the historical data, a training set of data, a validation set of data, and a test set of data are generated. The training set of data, the validation set of data, and the test set of data are stratified based on the amounts of scrap generated (e.g., 0% scrap, 0-1% scrap, 1-5% scrap, 5-10% scrap, greater than 10% scrap) to maintain balanced sets of data. Using balanced sets of data for training the hybrid machine learning model advantageously reduces skewed outcomes when making predictions on skewed and unbalanced data sets.

In some examples, the first machine learning model is trained based on the training set generated from the historical data. The first machine learning model is then evaluated and validated using the validation set. The first machine learning model is then tested using the test set. The second machine learning model is trained based on a subset of the training set that excludes instances where no scrap is generated (e.g., 0% scrap, zero scrap). The second machine learning model is then evaluated and validated using a subset of the validation set that excludes instances where no scrap is generated. The second machine learning model is then tested using a subset of the test set that excludes instances where no scrap is generated. As illustrated here, training the first machine learning model and the second machine learning model using a training set and a subset of the training set respectively advantageously allows the first machine learning model and the second machine learning model to achieve different objectives in generating predictions on skewed and unbalanced data sets.

In some examples, the historical data is processed to generate training data, validation data, and test data. Processing the historical data includes preprocessing the historical data to, for example, remove outliers, remove cancelled orders (e.g., cancelled confirmations), and filter irrelevant data. The historical data is further analyzed to combine partial data sets (e.g., partial confirmations) and calculate scrap percentages relative to planned quantities. Processing the historical data includes feature extraction and engineering to group features into feature categories. The historical data is further normalized to standardize the range of values provided in the historical data. Processing the historical data advantageously balances the training data to reduce skewed outcomes.

In some examples, feature extraction and engineering are performed using a large language model (LLM) or other machine learning techniques. Through automated text extraction and grouping of similar terms, operational terms in the historical data are consolidated into features that are consistent through the historical data. For example, terms that are related to the same feature but in different languages are consolidated together to represent the same feature. Terms related to the same category of features are consolidated together to create feature groups. Through the extraction and grouping of similar features, the wide range of features involved in manufacturing processes and other complex data sets are merged into features and feature groups that are readily analyzed by the hybrid machine learning model. Thus, as illustrated in these examples, a hybrid machine learning model for forecasting data addresses various technical problems arising from the application of AI technologies to database technologies to make predictions on skewed and unbalanced data sets.

The various examples described herein have various applications, such as predicting scrap generation, predicting production delays, predicting timing adjustments, and other applications where skewed and unbalanced data pose technical problems for generating predictions.

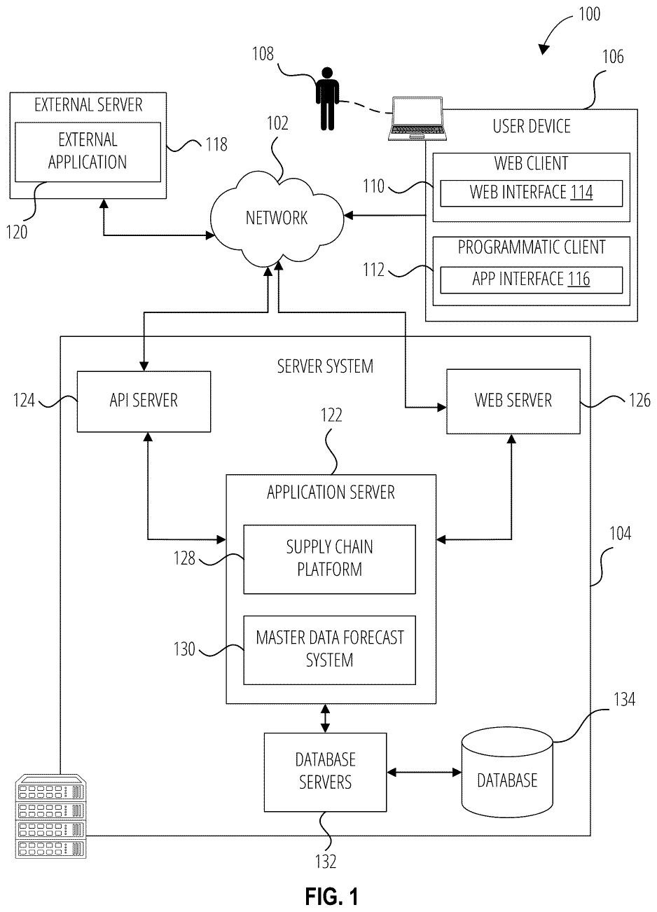

FIG. 1 is a diagrammatic representation of a networked computing environment 100 in which some examples of the present disclosure may be implemented or deployed. One or more servers in a server system 104 provide server-side functionality via a network 102 to a networked device, in the example form of a user device 106 that is accessed by a user 108. A web client 110 (e.g., a browser) or a programmatic client 112 (e.g., an “app”) may be hosted and executed on the user device 106.

An Application Program Interface (API) server 124 and a web server 126 provide respective programmatic and web interfaces to components of the server system 104. A specific application server 122 hosts a supply chain platform 128 and a master data forecast system 130, each of which includes components, modules, or applications. It is noted that the supply chain platform 128 and the master data forecast system 130 can be hosted via separate application servers in some examples.

The user device 106 can communicate with the application server 122, such as via the web interface supported by the web server 126 or via the programmatic interface provided by the API server 124. It will be appreciated that, although only a single user device 106 is shown in FIG. 1, a plurality of user devices may be communicatively coupled to the server system 104 in some examples. Further, while certain functions may be described herein as being performed at either the user device 106 (e.g., web client 110 or programmatic client 112) or the server system 104, the location of certain functionality either within the user device 106 or the server system 104 may be a design choice. Furthermore, while certain functions may be described herein as being performed at a particular system, such as the master data forecast system 130, the location of the functionality may also be a design choice. For instance, some functionality described with reference to the master data forecast system 130 can be performed by the supply chain platform 128 or by both the master data forecast system 130 and the supply chain platform 128.

The application server 122 is communicatively coupled to database servers 132, facilitating access to one or more information storage repositories, such as a database 134. In some examples, the database 134 includes storage devices that store information to be accessed, processed, modified, or deleted by the supply chain platform 128 or the master data forecast system 130.

The application server 122 accesses application data (e.g., application data stored by the database servers 132) to provide one or more applications or software tools to the user device 106 via a web interface 114 or an app interface 116. The supply chain platform 128 is an example of a platform with one or more applications or software tools, provided via the application server 122.

The supply chain platform 128 can facilitate the tracking, coordination, and execution of supply chain activities (e.g., ranging from procurement to distribution). In some examples, the supply chain platform 128 allows organizations to streamline and digitize their procurement lifecycle using a cloud-based architecture, integrating with the database 134 for fast processing of large data sets and real-time insights. Various data objects are created and used to manage and operate the supply chain platform 128. For example, various data objects, corresponding to real-world business entities or objects, can be mapped to tables in the database 134, and such tables (and thus their data objects) can be interconnected based on hierarchies, dependencies, or references.

In some examples, the supply chain platform 128 integrates with other systems to enhance functionality, such as interfacing with the master data forecast system 130 to ensure efficient data management. For instance, the supply chain platform 128 may utilize the master data forecast system 130 to predict a scrap percentage associated with a production order or a manufacturing process.

In some examples, the master data forecast system 130 is a centralized system configured to execute data purging operations on one or more storage systems associated with an enterprise based on defined purge policies or specific purge instructions. The master data forecast system 130 provides a platform to apply retention rules or other criteria for deleting obsolete, redundant, or unnecessary data. The master data forecast system 130 may delete specific or custom data items on request.

For example, the master data forecast system 130 handles requests to purge master data or transaction data associated with data objects created by users of the supply chain platform 128. In some examples, the supply chain platform 128 and the master data forecast system 130 work together to define a set of data objects that are in-scope for a particular data purge and to execute the data purge based on the purge scope.

It is noted that the supply chain platform 128 is merely an example of a platform or system that can benefit from features of the master data forecast system 130. The master data forecast system 130 can, for instance, operate to purge data associated with data objects related to other platforms or systems, such as human resources systems, enterprise resource planning (ERP) systems, or accounting systems.

In some examples, the application server 122 is part of a cloud-based platform provided by a software provider that allows the user 108 to utilize the tools of the supply chain platform 128, the master data forecast system 130, and, where applicable, other systems or subsystems (e.g., a human resources system, ERP system, or accounting system, as mentioned).

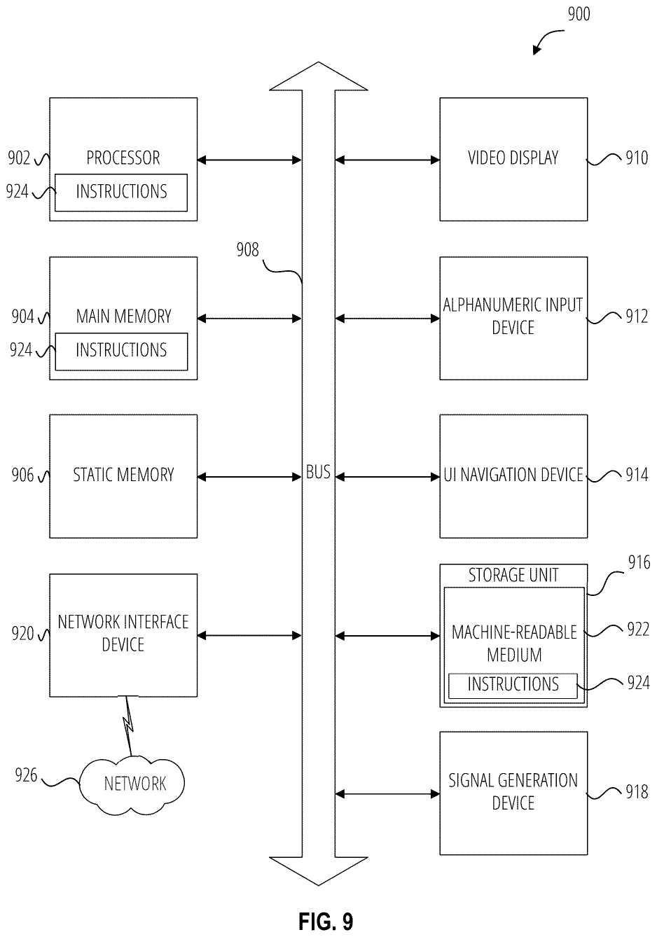

One or more of the application server 122, the database servers 132, the API server 124, the web server 126, and the supply chain platform 128 may each be implemented in a computer system, in whole or in part, as described below with respect to FIG. 9. In some examples, external applications (which may be third-party applications or other applications provided by the same software provider), such as an external server 118 executing on an external application 120, can communicate with the application server 122 via the programmatic interface provided by the API server 124. For example, a third-party application may support one or more features or functions on a website or platform hosted by a third party, or may perform certain methodologies and provide input or output information to the application server 122 for further processing.

The network 102 may be any network that enables communication between or among machines, databases, and devices. Accordingly, the network 102 may be a wired network, a wireless network (e.g., a mobile or cellular network), or any suitable combination thereof. The network 102 may include one or more portions that constitute a private network, a public network (e.g., the Internet), or any suitable combination thereof.

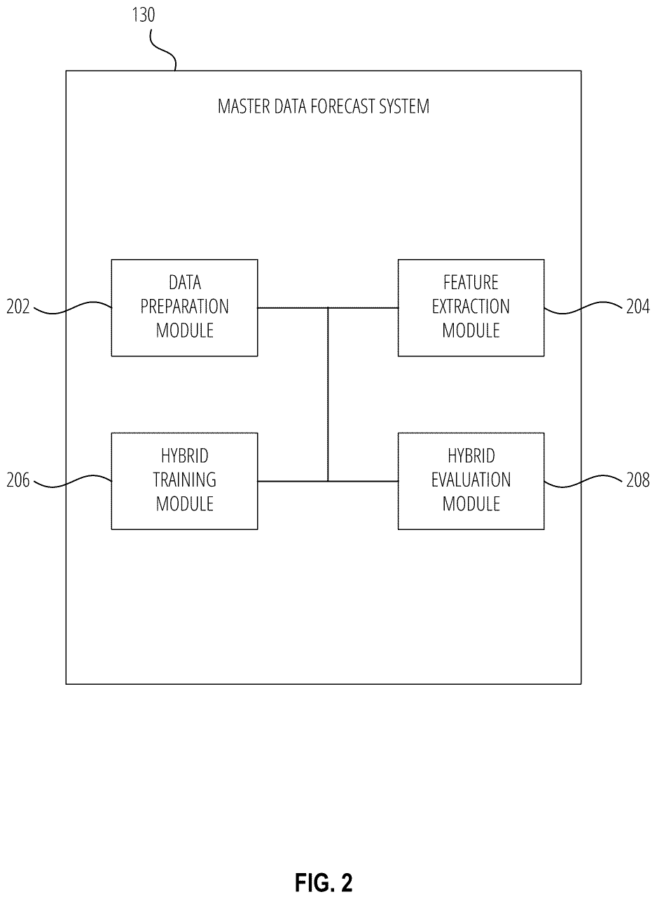

FIG. 2 is a block diagram illustrating components of the master data forecast system 130 of FIG. 1, according to some examples. In FIG. 2, the master data forecast system 130 is shown to include a data preparation module 202, a feature extraction module 204, a hybrid training module 206, and a hybrid evaluation module 208.

The data preparation module 202 prepares and analyzes historical data for use in training a hybrid machine learning model. In general, historical data includes data from various sources describing different manufacturing processes involving different materials, different work centers, different tools, and other differences. Preparation of the historical data includes removing outliers, handling null values and data types, consolidating partial data sets, and normalizing the data sets. Outliers are removed using, for example, a boxplot method. With the boxplot method, a range (e.g., first quartile to third quartile) is determined for data points to preserve. Data points that fall outside the range are removed as outliers.

Null values and data types are indicative of cancelled orders, incomplete orders, irrelevant data, and errors. In cases where the null values and data types indicate cancelled orders and incomplete orders, the data associated with the cancelled orders and the incomplete orders are removed. In cases where the null values and data types indicate irrelevant data and errors, the null values and data types are replaced with placeholders indicating the null values and data types are unknown.

Partial data sets arise when information related to a manufacturing process is entered at multiple stages of the manufacturing process. These partial data sets are identified based on their identifiers. For example, partial data sets from the same production order operation (or production operation) have the same order operation numbers. The partial data sets are combined to generate a complete data set corresponding with one production order operation, which is used as one instance of training data.

Data from various sources may use different units of measure and different terms to refer to the same features. Normalizing the data sets involves converting the different units of measure to the same unit of measure and consolidating the different term to refer to the same feature. To prepare the historical data for use as training data, a standardized data set of units of measure, features, and feature categories is determined. The historical data is converted to the units of measure and terminology of the normalized data set, allowing each data set of the historical data to be readily compared with each other and used as training data.

In some examples, normalizing the data involves normalizing numerical data to fall within a standardized range to remove wide variations in scales, such as variations between planned quantity sizes. For example, numerical features undergo a MinMaxScalar transformation to be scaled and transformed into a number within a fixed range (e.g., 0 to 1). Categorical features undergo a one-hot encoding transformation in which the text features are converted into numerical binary columns representing each categorical value. Categorical values undergo label encoding transformation in which numerical values for categorical features are converted into integer arrays or bins.

The feature extraction module 204 extracts features from historical data using machine learning techniques. A machine learning model (e.g., large language model) is instructed (e.g., prompted) to perform short text extraction on the historical data. The machine learning model is instructed to group similar features (e.g., features related to the same operations, materials, or tools) together. The machine learning model is instructed to merge features that are dependent upon each other (e.g., material features and quantity features).

For example, a feature group for a production resource tool (PRT) includes a PRT material count, a PRT material, a PRT equipment count, a PRT equipment, a PRT document count, and a PRT document for each PRT. A machine learning model is instructed to extract features related to PRTs and group them into this feature group structure by converting terms to normalized terms (e.g., PRT material count, PRT material, PRT equipment count, PRT equipment, PRT document count, PRT document) and converting units of measure to normalized units of measure. In some examples, the material features and quantity features (e.g., PRT material, PRT material count) are merged together into one feature (e.g., PRT material and material count).

Example feature groups include those for components, date and time, numerical features, equipment data, material related features, and work center features. A components group includes a component build of material, a component material group, whether the component is bulk, a component storage location, and a component supplier. A date and time group includes a scheduled production start and a scheduled production end. A numerical features group includes a planned order quantity, a net weight of materials, a duration of operation, a planned setup time, a planned process time, and a planned teardown time. An equipment data group includes an equipment manufacturer, an equipment number, a manufacturer model number, and a country of manufacture. A material related features group includes material groups, units of measure, builds of material, and material types. A work center features group includes work center locations, work center category codes, work center machine types, and storage locations. As illustrated in these examples, feature groups may include hierarchical feature groups and overlapping features.

In some examples, a count of selected features is extracted as a feature from historical data. The selected features are associated with, for example, a likelihood of scrap generation. A higher count of selected features is indicative of a higher likelihood of scrap generation relative to a lower count of selected features. In some examples, a feature group of selected features is maintained for features that, for example, signal a likelihood of scrap generation. A feature group of selected features includes, for example, work centers, work center locations, material quantities, operation short texts, machine types, components, scheduled end months, PRT material counts, planned quantity classes, operation durations, component groups, and scheduled process times.

The hybrid training module 206 facilitates training, validating, and testing a hybrid machine learning model. The hybrid machine learning model includes a first machine learning model that performs binary classification and a second machine learning model that predicts a value. Training the first machine learning model includes generating a set of training data, a set of validation data, and a set of testing data from the historical data. For example, the historical data, after it has been processed and normalized, is divided such that a first portion (e.g., 70%) of the historical data is used for the set of training data and a second portion (e.g., 30%) of the historical data is used for the set of validation data and the set of testing data. The training set of data, the validation set of data, and the test set of data are stratified based on the amounts of scrap generated (e.g., 0% scrap, 0-1% scrap, 1-5% scrap, 5-10% scrap, greater than 10% scrap) to maintain balanced sets of data. Each instance of training data includes features related to a production order operation and is labeled with an amount of scrap generated from the production order operation.

The first machine learning model is trained to generate a binary classification of whether scrap will be generated based on features of a production order operation (or production operation). The first machine learning model is trained to minimize a loss function between the outputs of the first machine learning model and the labels of the training data by adjusting weights and parameters of the first machine learning model to minimize the loss function.

The first machine learning model is validated using the set of validation data to estimate an accuracy of the first machine learning model as applied to data not included in the set of training data. The features of production order operations in the set of validation data are provided to the first machine learning model and the outputs of the first machine learning model are evaluated against the labels of the validation data indicating presence of scrap (e.g., amount of scrap greater than 0) generated for the production order operations in order to estimate the accuracy of the first machine learning model. In some examples, the first machine learning model is validated at different ranges or stratifications (e.g., 0% scrap, 0-1% scrap, 1-5% scrap, 5-10% scrap, greater than 10% scrap) to evaluate the accuracy of the first machine learning model at these different stratifications. Based on this evaluation, the weights and parameters of the first machine learning model are fine tuned to avoid overfitting of the first machine learning model on the set of training data and improve accuracy.

The first machine learning model is tested using the set of testing data to evaluate the accuracy of the first machine learning model as applied to data not included in the set of training data and the set of validation data. The features of production orders in the set of testing data are provided to the first machine learning model and the outputs of the first machine learning model are evaluated against the labels of the testing data indicating presence of scrap generated for the production orders in order to evaluate the accuracy of the first machine learning model.

The second machine learning model is trained to generate a value (e.g., percentage) of how much scrap will be generated based on features of a production order operation. The second machine learning model is trained using a subset of the training data used to train the first machine learning model. The subset excludes instances of training data in which no scrap (e.g., 0% scrap, zero scrap) is generated. The second machine learning model is trained to minimize a loss function between the outputs of the second machine learning model and the labels of the training data, which indicate how much scrap is generated, by adjusting weights and parameters of the second machine learning model to minimize the loss function.

The second machine learning model is validated using a subset of the set of validation data used to validate the first machine learning model. The subset excludes instances of validation data in which no scrap is generated. The features of production order operations (or production operations) in the subset of validation data are provided to the second machine learning model and the outputs of the second machine learning model are evaluated against the labels of the validation data, which indicate the amounts of scrap generated for the production order operations. In some examples, the second machine learning model is validated at different ranges or stratifications (e.g., 0-1% scrap, 1-5% scrap, 5-10% scrap, greater than 10% scrap). Based on this evaluation, the weights and parameters of the second machine learning model are fine tuned to improve the accuracy of the second machine learning model.

The second machine learning model is tested using a subset of the set of testing data used to test the first machine learning model. The subset excludes instances of testing data in which no scrap is generated. The features of production orders in the subset of testing data are provided to the second machine learning model and the outputs of the second machine learning model are evaluated against the labels of the testing data, which indicate the amounts of scrap generated for the production orders.

The hybrid evaluation module 208 uses the hybrid machine learning model to generate a prediction with respect to master data (e.g., scrap data). A production order and its related details are provided to the master data forecast system 130. The details are processed and normalized for analysis by the hybrid machine learning model. Based on features extracted from the production order operation, the hybrid machine learning model makes a determination as to whether scrap will be generated from the production order operation using the first machine learning model. If the determination is that no scrap will be generated, then an output indicating that no scrap will be generated is provided. If the determination is that scrap will be generated, the hybrid machine learning model makes a determination as to how much scrap will be generated from the production order using the second machine learning model. The determination as to how much scrap (e.g., scrap percentage) will be generated is provided as output.

In some examples, the hybrid machine learning model is incorporated in a production order interface that facilitates entering details related to a production order and displaying a prediction related to scrap generation based on the details. In cases where scrap generation is predicted, the details of the production order are automatically adjusted (e.g., automatically increased, automatically decreased, automatically changed) to account for a predicted amount of scrap generation. The production order interface presents the automatic adjustments by presenting the originally entered details, the automatic adjustments, and the current details, which account for the predicted amount of scrap generation.

For example, a company that manufactures bicycles may receive an order to manufacture 100 bicycles. The company creates a production order for 100 bicycles including various details such as the materials that will be used for the bicycles, where the bicycles will be produced, what tools will be used to produce the bicycles, and a planned duration for the production order. Features are extracted from the details of the production order using an LLM. The features are processed and normalized for analysis by the hybrid machine learning model. For example, the numerical features of the materials used for the bicycles are normalized and converted to standardized units of measure and terminology. These features are provided to the hybrid machine learning model which determines whether scrap will be generated from the production order and, if scrap will be generated, how much scrap will be generated. In this example, the hybrid machine learning model may determine that the scrap percentage is 5%, indicating that 5% of the materials used for production of the bicycles will be scrapped. The company uses this information to order sufficient materials (e.g., an additional 5%) to account for the predicted scrap generation and avoid delays in fulfilling the production order.

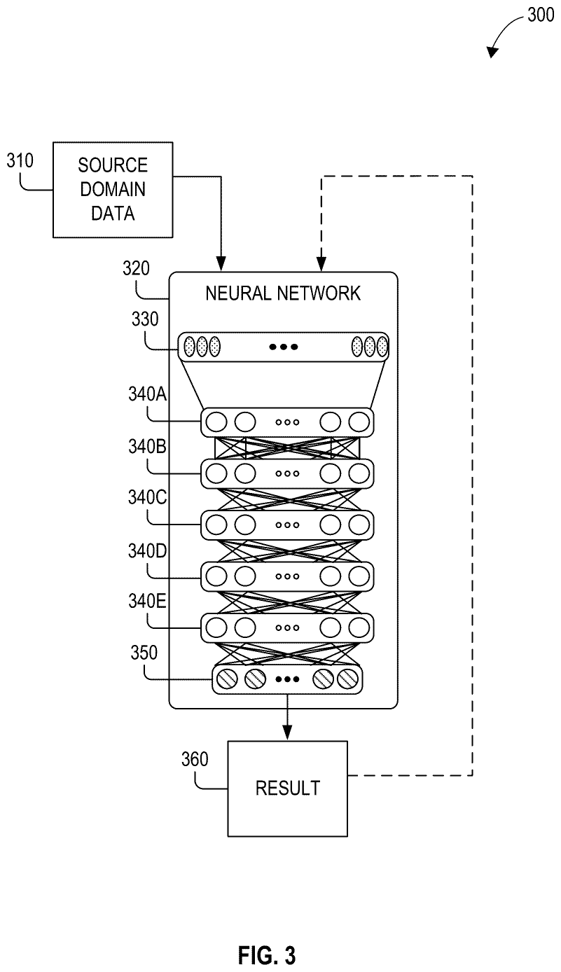

FIG. 3 is a block diagram of a neural network 320, suitable for use as a classifier or other machine learning model, according to some examples. The neural network 320 takes source domain data 310 as input and processes the source domain data 310 using an input layer 330; intermediate, hidden layers 340A, 340B, 340C, 340D, and 340E; and output layer 350 to generate a result 360.

A neural network, sometimes referred to as an artificial neural network, is a computing system based on consideration of biological neural networks of animal brains. Such systems progressively improve performance, which is referred to as learning, to perform tasks, typically without task-specific programming. For example, in image recognition, a neural network may be taught to identify images that contain an object by analyzing example images that have been tagged with a name for the object and having learned the object and name, may use the analytic results to identify the object in untagged images.

A neural network is based on a collection of connected units called neurons, where each connection, called a synapse, between neurons can transmit a unidirectional signal with an activating strength that varies with the strength of the connection. The receiving neuron can activate and propagate a signal to downstream neurons connected to it, typically based on whether the combined incoming signals, which are from potentially many transmitting neurons, are of sufficient strength, where strength is a parameter.

Each of the layers 330-350 comprises one or more nodes (or “neurons”). The nodes of the neural network 320 are shown as circles or ovals in FIG. 3. Each node takes one or more input values, processes the input values using zero or more internal variables, and generates one or more output values. The inputs to the input layer 330 are values from the source domain data 310. The output of the output layer 350 is the result 360. The intermediate layers 340A-340E are referred to as “hidden” because they do not interact directly with either the input or the output and are completely internal to the neural network 320. Though five hidden layers are shown in FIG. 3, more or fewer hidden layers may be used.

A model may be run against a training data set for several epochs, in which the training data set is repeatedly fed into the model to refine its results. In each epoch, the entire training data set is used to train the model. Multiple epochs (e.g., iterations over the entire training data set) may be used to train the model. In some example embodiments, the number of epochs is 10, 100, 500, or 1000. Within an epoch, one or more batches of the training data set are used to train the model. Thus, the batch size ranges between one and the size of the training data set while the number of epochs is any positive integer value. The model parameters are updated after each batch (e.g., using gradient descent).

For self-supervised learning, the training data set comprises self-labeled input examples. For example, a set of color images could be automatically converted to black-and-white images. Each color image may be used as a “label” for the corresponding black-and-white image and used to train a model that colorizes black-and-white images. This process is self-supervised because no additional information, outside of the original images, is used to generate the training data set. Similarly, when text is provided by a user, one word in a sentence can be masked and the network trained to predict the masked word based on the remaining words.

Each model develops a rule or algorithm over several epochs by varying the values of one or more variables affecting the inputs to more closely map to a desired result, but as the training data set may be varied, and is preferably very large, perfect accuracy and precision may not be achievable. A number of epochs that make up a learning phase, therefore, may be set as a given number of trials or a fixed time/computing budget, or may be terminated before that number/budget is reached when the accuracy of a given model is high enough or low enough or an accuracy plateau has been reached. For example, if the training phase is designed to run n epochs and produce a model with at least 95% accuracy, and such a model is produced before the nth epoch, the learning phase may end early and use the produced model satisfying the end-goal accuracy threshold. Similarly, if a given model is inaccurate enough to satisfy a random chance threshold (e.g., the model is only 55% accurate in determining true/false outputs for given inputs), the learning phase for that model may be terminated early, although other models in the learning phase may continue training. Similarly, when a given model continues to provide similar accuracy or vacillate in its results across multiple epochs—having reached a performance plateau—the learning phase for the given model may terminate before the epoch number/computing budget is reached.

Once the learning phase is complete, the models are finalized. In some example embodiments, models that are finalized are evaluated against testing criteria. In a first example, a testing data set that includes known outputs for its inputs is fed into the finalized models to determine an accuracy of the model in handling data that it has not been trained on. In a second example, a false positive rate or false negative rate may be used to evaluate the models after finalization. In a third example, a delineation between data clusters is used to select a model that produces the clearest bounds for its clusters of data.

The neural network 320 may be a deep learning neural network, a deep convolutional neural network (CNN), a recurrent neural network, a transformer neural network, or another type of neural network. A neuron is an architectural element used in data processing and artificial intelligence, particularly machine learning. A neuron implements a transfer function by which a number of inputs are used to generate an output. In some example embodiments, the inputs are weighted and summed, with the result compared to a threshold to determine if the neuron should generate an output signal (e.g., a 1) or not (e.g., a 0 output). The inputs of the component neurons are modified through the training of a neural network. One of skill in the art will appreciate that neurons and neural networks may be constructed programmatically (e.g., via software instructions) or via specialized hardware linking each neuron to form the neural network.

An example type of layer in the neural network 320 is a Long Short Term Memory (LSTM) layer. An LSTM layer includes several gates to handle input vectors (e.g., time-series data), a memory cell, and an output vector. The input gate and output gate control the information flowing into and out of the memory cell, respectively, whereas forget gates optionally remove information from the memory cell based on the inputs from linked cells earlier in the neural network. Weights and bias vectors for the various gates are adjusted over the course of a training phase, and once the training phase is complete, those weights and biases are finalized for normal operation.

A deep neural network (DNN) is a stacked neural network, which is composed of multiple layers. The layers are composed of nodes, which are locations where computation occurs, loosely patterned on a neuron in the human brain, which fires when it encounters sufficient stimuli. A node combines input from the data with a set of coefficients, or weights, that either amplify or dampen that input. Thus, the coefficients assign significance to inputs for the task the algorithm is trying to learn. These input-weight products are summed, and the sum is passed through what is called a node's activation function, to determine whether and to what extent that signal progresses further through the network to affect the ultimate outcome. A DNN uses a cascade of many layers of non-linear processing units for feature extraction and transformation. Each successive layer uses the output from the previous layer as input. Higher-level features are derived from lower-level features to form a hierarchical representation. The layers following the input layer may be convolution layers that produce feature maps that are filtering results of the inputs and are used by the next convolution layer.

In training of a DNN architecture, a regression, which is structured as a set of statistical processes for estimating the relationships among variables, can include a minimization of a cost function. The cost function may be implemented as a function to return a number representing how well the neural network performed in mapping training examples to correct output. In training, if the cost function value is not within a pre-determined range, based on the known training images, backpropagation is used, where backpropagation is a common method of training artificial neural networks that are used with an optimization method such as a stochastic gradient descent (SGD) method.

Use of backpropagation can include propagation and weight updates. When an input is presented to the neural network, it is propagated forward through the neural network, layer by layer, until it reaches the output layer. The output of the neural network is then compared to the desired output, using the cost function, and an error value is calculated for each of the nodes in the output layer. The error values are propagated backwards, starting from the output, until each node has an associated error value which roughly represents its contribution to the original output. Backpropagation can use these error values to calculate the gradient of the cost function with respect to the weights in the neural network. The calculated gradient is fed to the selected optimization method to update the weights to attempt to minimize the cost function.

In some example embodiments, the structure of each layer is predefined. For example, a convolution layer may contain small convolution kernels and their respective convolution parameters, and a summation layer may calculate the sum, or the weighted sum, of two or more values. Training assists in defining the weight coefficients for the summation.

One way to improve the performance of DNNs is to identify newer structures for the feature-extraction layers, and another way is by improving the way the parameters are identified at the different layers for accomplishing a desired task. For a given neural network, there may be millions of parameters to be optimized. Trying to optimize all these parameters from scratch may take hours, days, or even weeks, depending on the amount of computing resources available and the amount of data in the training set.

One of ordinary skill in the art will be familiar with several machine learning algorithms that may be applied with the present disclosure, including linear regression, random forests, decision tree learning, neural networks, DNNs, genetic or evolutionary algorithms, and the like. With the help of natural language processing (NLP) and advanced data pre-processing, a machine learning model (e.g., the neural network 320) can be trained on existing data (for instance, natural-language filtering instructions) from the system to generate corresponding output (e.g., database commands).

The transformer architecture processes an entire input at once rather than sequentially. For example, a recurrent neural network (RNN) processes words or sentences sequentially, with the output of the RNN treated as an input for each input after the first (thus the use of the word “recurrent” in the name). As a result, relationships between elements that are far apart in the input are difficult to detect. The transformer architecture receives a larger input and learns the interrelationships between the elements and the output using an attention mechanism. Since all elements are processed together, distance between the elements of the input does not affect the learning process. The output may still be generated sequentially, with the previous result (e.g., word for an LLM, pixel for an image-generating artificial intelligence, and the like) being provided as an input for determination of the next result.

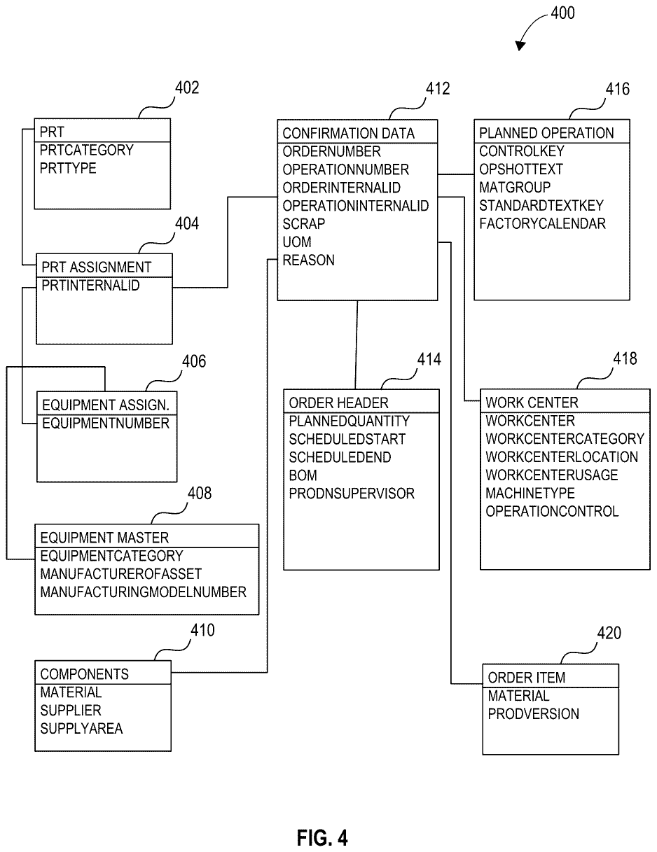

FIG. 4 is a block diagram of an example 400 of a relational database including details of a completed production order, according to some examples. One or more of the various functions described in the example 400 may be implemented by, for example, the master data forecast system 130 of FIG. 1 or FIG. 2 or a similar data forecast system.

The example 400 illustrates the relationships between tables of a relational database used in a production order. The example 400 includes a confirmation data table 412 that includes, for example, order number, operation number, internal identifiers, units of measure, an amount of scrap generated, and a reason for the scrap generation. The confirmation data table 412 is related to a planned operation data table 416 through its operation data, such as the operation number. The planned operation data table 416 includes, for example, control key, operation text, material group, standard text key, and factory calendar. The confirmation data table 412 is related to an order header table 414 through its order data, such as the order number. The order header table 414 includes, for example, planned quantity, scheduled start, scheduled end, bill of materials, and production supervisor information. The confirmation data table 412 is related to a work center data table 418 through its operation data, which identifies the work center. The work center data table 418 includes, for example, work center, work center category, work center location, work center usage, machine type, and operation control profile. The confirmation data table 412 is related to an order item data table 420 through its order data, which indicates materials ordered. The order item data table 420 includes, for example, material and production version information. The confirmation data table 412 is related to a components data table 410 through its operation data, which includes component information. The components data table 410 includes, for example, material, supplier, and supply area. The confirmation data table 412 is related to a PRT assignment data table 404 through its operation data, which includes PRT information. The PRT assignment data table 404 includes, for example, PRT internal identifier. The PRT assignment data table 404 is related to a PRT data table 402 through its internal identifier. The PRT data table 402 includes, for example, PRT category and PRT type. The PRT assignment data table 404 is related to an equipment assignment data table 406 through its internal identifier. The equipment assignment data table 406 includes, for example, equipment number. The equipment assignment data table 406 is related to an equipment master data table 408 through its equipment number. The equipment master data table 408 includes, for example, equipment category, manufacturer of asset, and manufacturing model number.

As illustrated in the example 400, the data involved in a production order is complex and interrelated with the various details identified in the example 400 all potentially contributing to the generation of scrap. The data illustrated in the example 400 is processed and normalized to generate an instance of training data for training the hybrid machine learning model. Processing the data illustrated in the example 400 includes extracting features from the details associated with the production order operation. The numerical features are normalized to a standardized data set.

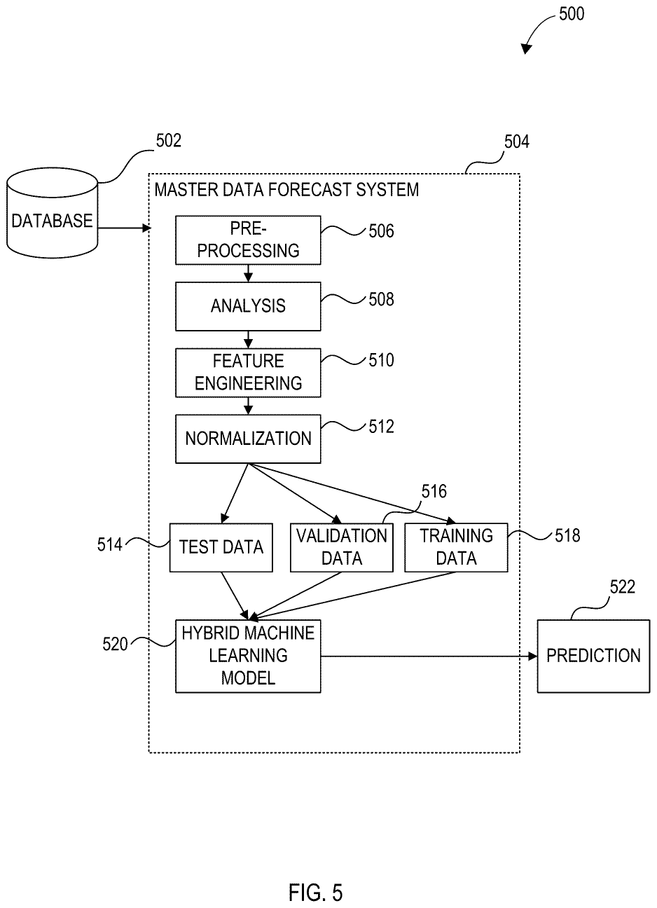

FIG. 5 is a block diagram of an example 500 of training a hybrid machine learning model, according to some examples. One or more of the various functions described in the example 500 may be implemented by, for example, the master data forecast system 130 of FIG. 1 or FIG. 2 or a similar data forecast system.

As illustrated in the example 500, a hybrid machine learning model 520 of a master data forecast system 504 is trained based on historical data in a database 502. The historical data includes, for example, production orders that resulted in generation of scrap and production orders that resulted in no generation of scrap. The master data forecast system 504 preforms preprocessing 506 on the historical data. The preprocessing 506 includes, for example, removing outliers, removing cancelled orders (e.g., cancelled confirmations), and filtering irrelevant data. The master data forecast system 504 performs analysis 508 on the historical data. The analysis 508 includes, for example, combining partial data sets (e.g., partial confirmations) and converting amounts of scrap generated to scrap percentages relative to planned quantities. The master data forecast system 504 performs feature engineering 510 on the historical data. The feature engineering 510 includes, for example, extracting features from the historical data and grouping the features into feature categories. The master data forecast system 504 performs normalization 512 on the historical data. The normalization 512 includes, for example, standardizing the range of values provided in the historical data and converting the data sets to standardized data sets. Following the preprocessing 506, the analysis 508, the feature engineering 510, and the normalization 512, the historical data is divided into test data 514, validation data 516, and training data 518. The master data forecast system 504 trains the hybrid machine learning model 520 based on the training data 518. During training, the master data forecast system 504 fine tunes the hybrid machine learning model 520 based on the validation data 516. The master data forecast system 504 tests the training of the hybrid machine learning model 520 based on the test data 514. After training, the hybrid machine learning model 520 is applied to a production order to generate a prediction 522. The prediction 522 includes, for example, a predicted scrap percentage generated from the production order.

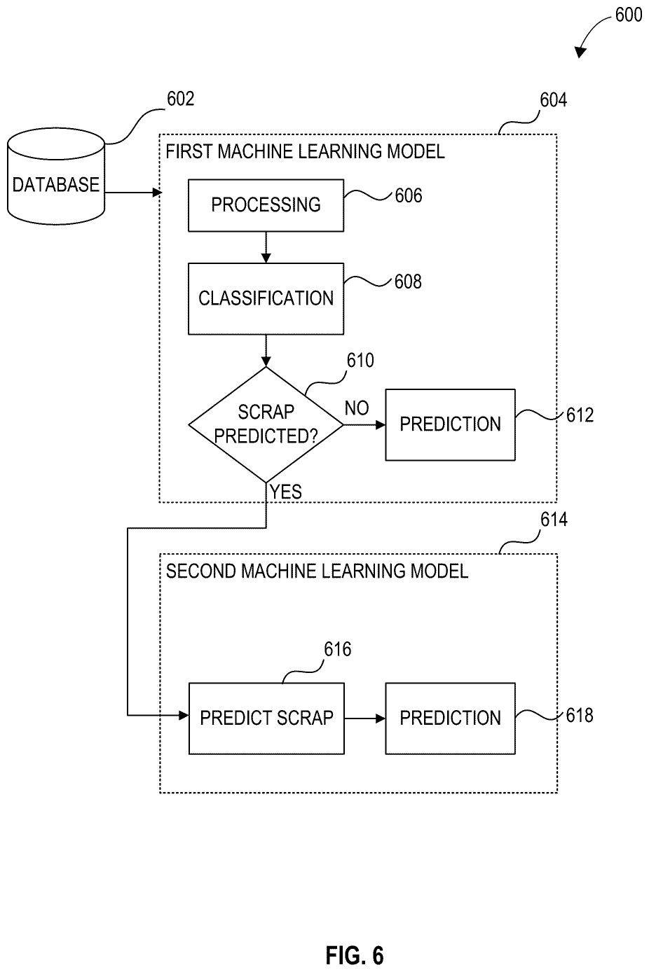

FIG. 6 is a block diagram of an example 600 of using a hybrid machine learning model, according to some examples. One or more of the various functions described in the example 600 may be implemented by, for example, the master data forecast system 130 of FIG. 1 or FIG. 2 or a similar data forecast system.

As illustrated in the example 600, information related to a production order operation is provided to a first machine learning model 604 of the hybrid machine learning model. In some examples, the first machine learning model 604 is a balanced random forest classifier. Processing 606 is performed on the information related to the production order to extract features from the information and normalize the extracted features. A classification 608 is performed based on the extracted features of the production order. At 610 a determination is made as to whether scrap is predicted. If no scrap is predicted, then a prediction 612 that no scrap will be generated is output, for example, to a user interface. If scrap is predicted, then the extracted features of the production order are provided to a second machine learning model 614 of the hybrid machine learning model. In some examples, the second machine learning model 614 is a gradient boosting regressor. At 616, the second machine learning model 614 predicts an amount of scrap that the production order will generate. A prediction 618 indicating the amount of scrap that the production order will generate is output, for example, to a user interface.

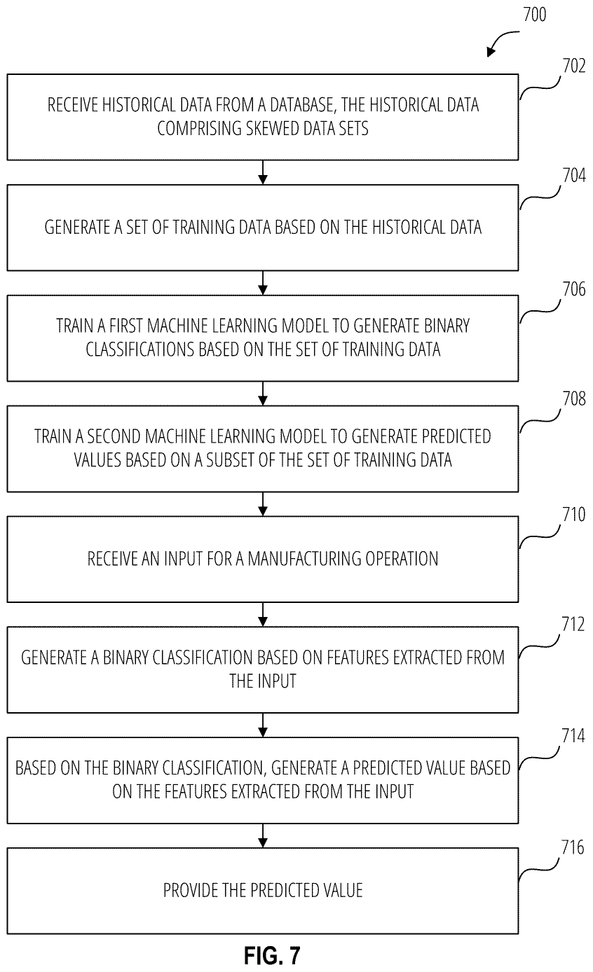

FIG. 7 is a flowchart showing an example method 700, according to some examples. One or more of the functions described in the example method 700 may be implemented by, for example, the master data forecast system 130 of FIG. 1 or FIG. 2 or a similar data forecast system. Although the flowchart depicts a particular sequence of operations, the sequence may be altered without departing from the scope of the subject matter disclosed herein. For example, some of the operations depicted may be performed in parallel or in a different sequence without materially affecting the functions described in the example method 700.

The example method 700 includes operations performed by a data forecast system. At operation 702, the data forecast system receives historical data combined/joined with master data from a database, the historical data comprising skewed data sets. At operation 704, the data forecast system generates a set of training data based on the historical data. At operation 706, the data forecast system trains a first machine learning model to generate binary classifications based on the set of training data. At operation 708, the data forecast system trains a second machine learning model to generate predicted values based on a subset of the set of training data. At operation 710, the data forecast system receives an input for a manufacturing operation. At operation 712, the data forecast system generates a binary classification based on features extracted from the input. At operation 714, the data forecast system, based on the binary classification, generates a predicted value based on the features extracted from the input. At operation 716, the data forecast system provides the predicted value.

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a system comprising: at least one memory that stores instructions; and one or more processors configured by the instructions to perform operations comprising: receiving historical data from a database, the historical data comprising skewed data sets; generating a set of training data based on the skewed data sets; training a first machine learning model to generate binary classifications based on the set of training data; training a second machine learning model to generate predicted values based on a subset of the set of training data; receiving an input for a manufacturing operation; generating a binary classification based on features extracted from the input; based on the binary classification, generating a predicted value based on the features extracted from the input; and providing the predicted value.

In Example 2, the subject matter of Example 1 comprises generating a set of validation data based on the skewed data sets; tuning the first machine learning model based on the set of validation data; and tuning the second machine learning model based on a subset of the set of validation data.

In Example 3, the subject matter of any of Examples 1-2 comprises generating a set of testing data based on the skewed data sets; evaluating the first machine learning model based on the set of testing data; and evaluating the second machine learning model based on a subset of the set of testing data.

In Example 4, the subject matter of any of Examples 1-3 comprises removing outliers from the skewed data sets; replacing null values and data types in the skewed data sets with placeholders; and combining partial data sets in the skewed data sets.

In Example 5, the subject matter of any of Examples 1-4 comprises determining a standardized data set comprising a standardized set of units of measure and a standardized set of features; converting the skewed data sets based on the standardized data set; and converting the input based on the standardized data set.

In Example 6, the subject matter of any of Examples 1-5 comprises normalizing numerical features in the skewed data sets based on a standardized range of values; and normalizing the input based on the standardized range of values.

In Example 7, the subject matter of any of Examples 1-6 comprises wherein the features are extracted from the input using a large language model.

In Example 8, the subject matter of any of Examples 1-7 comprises wherein the subset of the set of training data excludes instances associated with predicted values of zero.

In Example 9, the subject matter of any of Examples 1-8 comprises wherein the predicted value is a percentage value indicating a percentage of scrap generated.

In Example 10, the subject matter of any of Examples 1-9 comprises automatically adjusting the input based on the predicted value.

Example 11 is a method comprising, receiving historical data from a database, the historical data comprising skewed data sets; generating a set of training data based on the skewed data sets; training a first machine learning model to generate binary classifications based on the set of training data; training a second machine learning model to generate predicted values based on a subset of the set of training data; receiving an input for a manufacturing operation; generating a binary classification based on features extracted from the input; based on the binary classification, generating a predicted value based on the features extracted from the input; and providing the predicted value.

In Example 12, the subject matter of Examples 11 comprises generating a set of validation data based on the skewed data sets; tuning the first machine learning model based on the set of validation data; and tuning the second machine learning model based on a subset of the set of validation data.

In Example 13, the subject matter of any of Examples 11-12 comprises generating a set of testing data based on the skewed data sets; evaluating the first machine learning model based on the set of testing data; and evaluating the second machine learning model based on a subset of the set of testing data.

In Example 14, the subject matter of any of Examples 11-13 comprises removing outliers from the skewed data sets; replacing null values and data types in the skewed data sets with placeholders; and combining partial data sets in the skewed data sets.

In Example 15, the subject matter of any of Examples 11-14 comprises determining a standardized data set comprising a standardized set of units of measure and a standardized set of features; converting the skewed data sets based on the standardized data set; and converting the input based on the standardized data set.

Example 16 is one or more non-transitory computer-readable media storing computer-executable instructions that, when executed by a computing system, cause the computing system to perform operations comprising: receiving historical data from a database, the historical data comprising skewed data sets; generating a set of training data based on the skewed data sets; training a first machine learning model to generate binary classifications based on the set of training data; training a second machine learning model to generate predicted values based on a subset of the set of training data; receiving an input for a manufacturing operation; generating a binary classification based on features extracted from the input; based on the binary classification, generating a predicted value based on the features extracted from the input; and providing the predicted value.

In Example 17, the subject matter of Examples 16 comprises generating a set of validation data based on the skewed data sets; tuning the first machine learning model based on the set of validation data; and tuning the second machine learning model based on a subset of the set of validation data.

In Example 18, the subject matter of any of Examples 16-17 comprises generating a set of testing data based on the skewed data sets; evaluating the first machine learning model based on the set of testing data; and evaluating the second machine learning model based on a subset of the set of testing data.

In Example 19, the subject matter of any of Examples 16-18 comprises removing outliers from the skewed data sets; replacing null values and data types in the skewed data sets with placeholders; and combining partial data sets in the skewed data sets.

In Example 20, the subject matter of any of Examples 16-19 comprises determining a standardized data set comprising a standardized set of units of measure and a standardized set of features; converting the skewed data sets based on the standardized data set; and converting the input based on the standardized data set.

Example 21 is an apparatus comprising means to implement any of Examples 1-20.

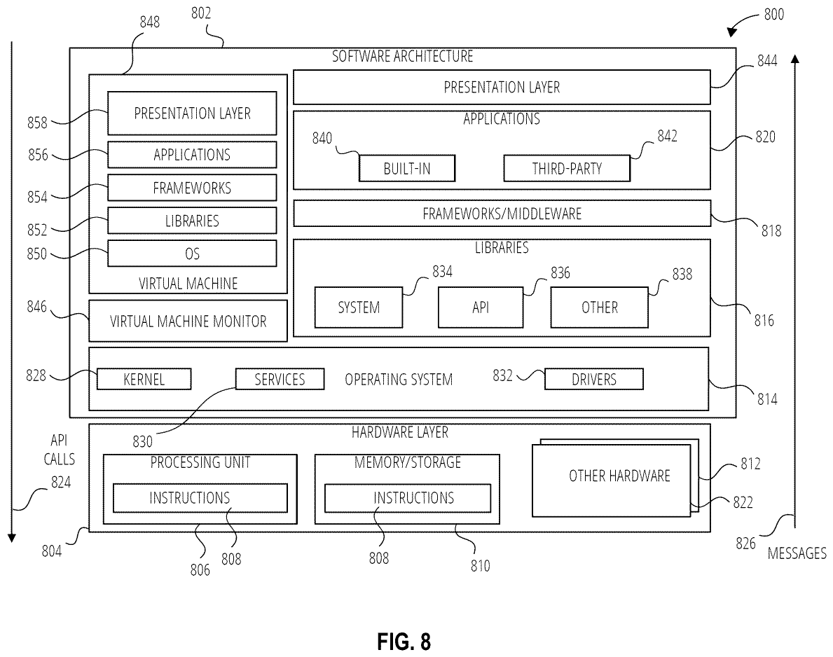

FIG. 8 is a block diagram 800 showing a software architecture 802 for a computing device, according to some examples. The software architecture 802 may be used in conjunction with various hardware architectures, for example, as described herein. FIG. 8 is merely a non-limiting illustration of a software architecture, and many other architectures may be implemented to facilitate the functionality described herein. A representative hardware layer 804 is illustrated and can represent, for example, any of the above referenced computing devices. In some examples, the hardware layer 804 may be implemented according to the architecture of the computer system of FIG. 9.

The representative hardware layer 804 comprises one or more processing units 806 having associated executable instructions 808. Executable instructions 808 represent the executable instructions of the software architecture 802, including implementation of the methods, modules, subsystems, and components, and so forth described herein and may also include memory and/or storage modules 810, which also have executable instructions 808. Hardware layer 804 may also comprise other hardware as indicated by other hardware 812 and other hardware 822 which represent any other hardware of the hardware layer 804, such as the other hardware illustrated as part of the software architecture 802.

In the architecture of FIG. 8, the software architecture 802 may be conceptualized as a stack of layers where each layer provides particular functionality. For example, the software architecture 802 may include layers such as an operating system 814, libraries 816, frameworks/middleware layer 818, applications 820, and presentation layer 844. Operationally, the applications 820 or other components within the layers may invoke API calls 824 through the software stack and access a response, returned values, and so forth illustrated as messages 826 in response to the API calls 824. The layers illustrated are representative in nature and not all software architectures have all layers. For example, some mobile or special purpose operating systems may not provide a frameworks/middleware layer 818, while others may provide such a layer. Other software architectures may include additional or different layers.

The operating system 814 may manage hardware resources and provide common services. The operating system 814 may include, for example, a kernel 828, services 830, and drivers 832. The kernel 828 may act as an abstraction layer between the hardware and the other software layers. For example, the kernel 828 may be responsible for memory management, processor management (e.g., scheduling), component management, networking, security settings, and so on. The services 830 may provide other common services for the other software layers. In some examples, the services 830 include an interrupt service. The interrupt service may detect the receipt of an interrupt and, in response, cause the software architecture 802 to pause its current processing and execute an interrupt service routine (ISR) when an interrupt is accessed.

The drivers 832 may be responsible for controlling or interfacing with the underlying hardware. For instance, the drivers 832 may include display drivers, camera drivers, Bluetooth® drivers, flash memory drivers, serial communication drivers (e.g., Universal Serial Bus (USB) drivers), Wi-Fi® drivers, near-field communication (NFC) drivers, audio drivers, power management drivers, and so forth depending on the hardware configuration.

The libraries 816 may provide a common infrastructure that may be utilized by the applications 820 or other components or layers. The libraries 816 typically provide functionality that allows other software modules to perform tasks in an easier fashion than to interface directly with the underlying operating system 814 functionality (e.g., kernel 828, services 830 or drivers 832). The libraries 816 may include system libraries 834 (e.g., C standard library) that may provide functions such as memory allocation functions, string manipulation functions, mathematic functions, and the like. In addition, the libraries 816 may include API libraries 836 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 816 may also include a wide variety of other libraries 838 to provide many other APIs to the applications 820 and other software components/modules.

The frameworks/middleware layer 818 may provide a higher-level common infrastructure that may be utilized by the applications 820 or other software components/modules. For example, the frameworks/middleware layer 818 may provide various graphic user interface (GUI) functions, high-level resource management, high-level location services, and so forth. The frameworks/middleware layer 818 may provide a broad spectrum of other APIs that may be utilized by the applications 820 or other software components/modules, some of which may be specific to a particular operating system or platform.

The applications 820 include built-in applications 840 or third-party applications 842. Examples of representative built-in applications 840 may include, but are not limited to, a contacts application, a browser application, a book reader application, a location application, a media application, a messaging application, or a game application. Third-party applications 842 may include any of the built-in applications as well as a broad assortment of other applications. In a specific example, the third-party application 842 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 842 may invoke the API calls 824 provided by the mobile operating system such as operating system 814 to facilitate functionality described herein.

The applications 820 may utilize built in operating system functions (e.g., kernel 828, services 830 or drivers 832), libraries (e.g., system libraries 834, API libraries 836, and other libraries 838), and frameworks/middleware layer 818 to create user interfaces to interact with users of the system. Alternatively, or additionally, in some systems, interactions with a user may occur through a presentation layer, such as presentation layer 844. In these systems, the application/module “logic” can be separated from the aspects of the application/module that interact with a user.

Some software architectures utilize virtual machines. In the example of FIG. 8, this is illustrated by virtual machine 848. A virtual machine creates a software environment where applications/modules can execute as if they were executing on a hardware computing device. A virtual machine is hosted by a host operating system (operating system 814) and typically, although not always, has a virtual machine monitor 846, which manages the operation of the virtual machine as well as the interface with the host operating system (e.g., operating system 814). A software architecture executes within the virtual machine 848 such as an operating system 850, libraries 852, frameworks/middleware 854, applications 856 or presentation layer 858. These layers of software architecture executing within the virtual machine 848 can be the same as corresponding layers previously described or may be different.

Certain examples are described herein as including logic or a number of components, modules, or mechanisms. Modules or components may constitute either software modules/components (e.g., code embodied (1) on a non-transitory machine-readable medium or (2) in a transmission signal) or hardware-implemented modules/components. A hardware-implemented module/component is a tangible unit capable of performing certain operations and may be configured or arranged in a certain manner. In examples, one or more computer systems (e.g., a standalone, client, or server computer system) or one or more hardware processors may be configured by software (e.g., an application or application portion) as a hardware-implemented module/component that operates to perform certain operations as described herein.

In various examples, a hardware-implemented module/component may be implemented mechanically or electronically. For example, a hardware-implemented module/component may comprise dedicated circuitry or logic that is permanently configured (e.g., as a special-purpose processor, such as a field programmable gate array (FPGA) or an application-specific integrated circuit (ASIC)) to perform certain operations. A hardware-implemented module/component may also comprise programmable logic or circuitry (e.g., as encompassed within a general-purpose processor or another programmable processor) that is temporarily configured by software to perform certain operations.

Accordingly, the term “hardware-implemented module” or “hardware-implemented component” should be understood to encompass a tangible entity, be that an entity that is physically constructed, permanently configured (e.g., hardwired), or temporarily or transitorily configured (e.g., programmed) to operate in a certain manner or to perform certain operations described herein. Considering examples in which hardware-implemented modules/components are temporarily configured (e.g., programmed), each of the hardware-implemented modules/components need not be configured or instantiated at any one instance in time. For example, where the hardware-implemented modules/components comprise, a general-purpose processor configured using software, the general-purpose processor may be configured as respective different hardware-implemented modules/components at different times. Software may accordingly configure a processor, for example, to constitute a particular hardware-implemented module/component at one instance of time and to constitute a different hardware-implemented module/component at a different instance of time.

Hardware-implemented modules/components can provide information to, and receive information from, other hardware-implemented modules/components. Accordingly, the described hardware-implemented modules/components may be regarded as being communicatively coupled. Where multiple of such hardware-implemented modules/components exist contemporaneously, communications may be achieved through signal transmission (e.g., over appropriate circuits and buses that connect the hardware-implemented modules/components). In examples in which multiple hardware-implemented modules/components are configured or instantiated at different times, communications between such hardware-implemented modules/components may be achieved, for example, through the storage and retrieval of information in memory structures to which the multiple hardware-implemented modules/components have access. For example, one hardware-implemented module/component may perform an operation and store the output of that operation in a memory device to which it is communicatively coupled. A further hardware-implemented module/component may then, at a later time, access the memory device to retrieve and process the stored output.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules/components that operate to perform one or more operations or functions. The modules/components referred to herein may, in some examples, comprise processor-implemented modules/components.

Similarly, the methods described herein may be at least partially processor-implemented. For example, at least some of the operations of a method may be performed by one or more processors or processor-implemented modules/components. The performance of certain of the operations may be distributed among the one or more processors, not only residing within a single machine, but deployed across a number of machines.

The one or more processors may also operate to support performance of the relevant operations in a “cloud computing” environment or as a “software as a service (SaaS).” For example, at least some of the operations may be performed by a group of computers (as examples of machines including processors), these operations being accessible via a network (e.g., the Internet) and via one or more appropriate interfaces (e.g., APIs).

Examples may be implemented in digital electronic circuitry, or in computer hardware, firmware, or software, or in combinations of them. Examples may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

FIG. 9 is a block diagram of a machine in the example form of a computer system 900 within which instructions 924 may be executed for causing the machine to perform any one or more of the methodologies discussed herein. In alternative examples, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a GPU, or both), a primary or main memory 904, and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard or a touch-sensitive display screen), a UI navigation (or cursor control) device 914 (e.g., a mouse), a storage unit 916, a signal generation device 918 (e.g., a speaker), and a network interface device 920.

As used herein, the term “processor” may refer to any one or more circuits or virtual circuits (e.g., a physical circuit emulated by logic executing on an actual processor) that manipulates data values according to control signals (e.g., commands, opcodes, machine code, control words, macroinstructions, etc.) and which produces corresponding output signals that are applied to operate a machine. A processor may, for example, include at least one of a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), a Tensor Processing Unit (TPU), a Neural Processing Unit (NPU), a Vision Processing Unit (VPU), a Machine Learning Accelerator, an Artificial Intelligence Accelerator, an Application Specific Integrated Circuit (ASIC), a Field Programmable Gate Array (FPGA), a Radio-Frequency Integrated Circuit (RFIC), a Neuromorphic Processor, a Quantum Processor, or any combination thereof. A processor may be a multi-core processor having two or more independent processors (sometimes referred to as “cores”) that may execute instructions contemporaneously. Multi-core processors may contain multiple computational cores on a single integrated circuit die, each of which can independently execute program instructions in parallel. Parallel processing on multi-core processors may be implemented via architectures like superscalar, VLIW, vector processing, or SIMD that allow each core to run separate instruction streams concurrently. A processor may be emulated in software, running on a physical processor, as a virtual processor or virtual circuit. The virtual processor may behave like an independent processor but is implemented in software rather than hardware.

The storage unit 916 includes a machine-readable medium 922 on which is stored one or more sets of data structures and instructions 924 (e.g., software) embodying or utilized by any one or more of the methodologies or functions described herein. The instructions 924 may also reside, completely or at least partially, within the main memory 904 or within the processor 902 during execution thereof by the computer system 900, with the main memory 904 and the processor 902 also each constituting a machine-readable medium 922.

While the machine-readable medium 922 is shown in accordance with some examples to be a single medium, the term “machine-readable medium” may include a single medium or multiple media (e.g., a centralized or distributed database, or associated caches and servers) that store the one or more instructions 924 or data structures. The term “machine-readable medium” shall also be taken to include any tangible medium that is capable of storing, encoding, or carrying instructions 924 for execution by the machine and that cause the machine to perform any one or more of the methodologies of the present disclosure, or that is capable of storing, encoding, or carrying data structures utilized by or associated with such instructions 924. The term “machine-readable medium” shall accordingly be taken to include, but not be limited to, solid-state memories, and optical and magnetic media. Specific examples of a machine-readable medium 922 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM) disks. A machine-readable medium is not a transmission medium.

The instructions 924 may further be transmitted or received over a communications network 926 using a transmission medium. The instructions 924 may be transmitted using the network interface device 920 and any one of a number of well-known transfer protocols (e.g., hypertext transport protocol (HTTP)). Examples of communication networks include a local area network (LAN), a wide area network (WAN), the Internet, mobile telephone networks, plain old telephone (POTS) networks, and wireless data networks (e.g., Wi-Fi and Wi-Max networks). The term “transmission medium” shall be taken to include any intangible medium that is capable of storing, encoding, or carrying instructions 924 for execution by the machine, and includes digital or analog communications signals or other intangible media to facilitate communication of such software.

Although specific examples are described herein, it will be evident that various modifications and changes may be made to these examples without departing from the broader spirit and scope of the disclosure. Accordingly, the specification and drawings are to be regarded in an illustrative rather than a restrictive sense. The accompanying drawings that form a part hereof show by way of illustration, and not of limitation, specific examples in which the subject matter may be practiced. The examples illustrated are described in sufficient detail to enable those skilled in the art to practice the teachings disclosed herein. Other examples may be utilized and derived therefrom, such that structural and logical substitutions and changes may be made without departing from the scope of this disclosure. This detailed description, therefore, is not to be taken in a limiting sense, and the scope of various examples is defined only by the appended claims, along with the full range of equivalents to which such claims are entitled.

Such examples of the subject matter may be referred to herein, individually or collectively, by the term “example” merely for convenience and without intending to voluntarily limit the scope of this application to any single example or concept if more than one is in fact disclosed. Thus, although specific examples have been illustrated and described herein, it should be appreciated that any arrangement calculated to achieve the same purpose may be substituted for the specific examples shown. This disclosure is intended to cover any and all adaptations or variations of various examples. Combinations of the above examples, and other examples not specifically described herein, will be apparent to those of skill in the art upon reviewing the above description.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number, respectively. Except as otherwise indicated, the word “or” in reference to a list of two or more items, covers all of the following interpretations of the word: any one of the items in the list, all of the items in the list, and any combination of the items in the list.

Although some examples, such as those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence. The term “operation” is used to refer to elements in the drawings of this disclosure for ease of reference and it will be appreciated that each “operation” may identify one or more operations, processes, actions, or steps, and may be performed by one or multiple components.

What is claimed is:

1. A system comprising:
at least one memory that stores instructions; and
one or more processors that, when executing the instructions, perform operations comprising:
receiving historical data from a database, the historical data comprising skewed data sets;
generating a set of training data based on the skewed data sets;
training a first machine learning model to generate binary classifications based on the set of training data;
training a second machine learning model to generate predicted values based on a subset of the set of training data;
receiving an input for a manufacturing operation;
generating a binary classification based on features extracted from the input;
based on the binary classification, generating a predicted value based on the features extracted from the input; and
providing the predicted value.

2. The system of claim 1, the operations further comprising:
generating a set of validation data based on the skewed data sets;
tuning the first machine learning model based on the set of validation data; and
tuning the second machine learning model based on a subset of the set of validation data.

3. The system of claim 1, the operations further comprising:
generating a set of testing data based on the skewed data sets;
evaluating the first machine learning model based on the set of testing data; and
evaluating the second machine learning model based on a subset of the set of testing data.

4. The system of claim 1, the operations further comprising:
removing outliers from the skewed data sets;
replacing null values and data types in the skewed data sets with placeholders; and
combining partial data sets in the skewed data sets.

5. The system of claim 1, the operations further comprising:
determining a standardized data set comprising a standardized set of units of measure and a standardized set of features;
converting the skewed data sets based on the standardized data set; and
converting the input based on the standardized data set.

6. The system of claim 1, the operations further comprising:
normalizing numerical features in the skewed data sets based on a standardized range of values; and
normalizing the input based on the standardized range of values.

7. The system of claim 1, wherein the features are extracted from the input using a large language model.

8. The system of claim 1, wherein the subset of the set of training data excludes instances associated with predicted values of zero.

9. The system of claim 1, wherein the predicted value is a percentage value indicating a percentage of scrap generated.

10. The system of claim 1, the operations further comprising:
automatically adjusting the input based on the predicted value.

11. A method comprising,
receiving historical data from a database, the historical data comprising skewed data sets;
generating a set of training data based on the skewed data sets;
training a first machine learning model to generate binary classifications based on the set of training data;
training a second machine learning model to generate predicted values based on a subset of the set of training data;
receiving an input for a manufacturing operation;
generating a binary classification based on features extracted from the input;
based on the binary classification, generating a predicted value based on the features extracted from the input; and
providing the predicted value.

12. The method of claim 11, further comprising:
generating a set of validation data based on the skewed data sets;
tuning the first machine learning model based on the set of validation data; and
tuning the second machine learning model based on a subset of the set of validation data.

13. The method of claim 11, further comprising:
generating a set of testing data based on the skewed data sets;
evaluating the first machine learning model based on the set of testing data; and
evaluating the second machine learning model based on a subset of the set of testing data.

14. The method of claim 11, further comprising:
removing outliers from the skewed data sets;
replacing null values and data types in the skewed data sets with placeholders; and
combining partial data sets in the skewed data sets.

15. The method of claim 11, further comprising:
determining a standardized data set comprising a standardized set of units of measure and a standardized set of features;
converting the skewed data sets based on the standardized data set; and
converting the input based on the standardized data set.

16. One or more non-transitory computer-readable media storing computer-executable instructions that, when executed by a computing system, cause the computing system to perform operations comprising:
receiving historical data from a database, the historical data comprising skewed data sets;
generating a set of training data based on the skewed data sets;
training a first machine learning model to generate binary classifications based on the set of training data;
training a second machine learning model to generate predicted values based on a subset of the set of training data;
receiving an input for a manufacturing operation;
generating a binary classification based on features extracted from the input;
based on the binary classification, generating a predicted value based on the features extracted from the input; and
providing the predicted value.

17. The one or more non-transitory computer-readable media of claim 16, the operations further comprising:
generating a set of validation data based on the skewed data sets;
tuning the first machine learning model based on the set of validation data; and
tuning the second machine learning model based on a subset of the set of validation data.

18. The one or more non-transitory computer-readable media of claim 16, the operations further comprising:
generating a set of testing data based on the skewed data sets;
evaluating the first machine learning model based on the set of testing data; and
evaluating the second machine learning model based on a subset of the set of testing data.

19. The one or more non-transitory computer-readable media of claim 16, the operations further comprising:
removing outliers from the skewed data sets;
replacing null values and data types in the skewed data sets with placeholders; and
combining partial data sets in the skewed data sets.

20. The one or more non-transitory computer-readable media of claim 16, the operations further comprising:
determining a standardized data set comprising a standardized set of units of measure and a standardized set of features;
converting the skewed data sets based on the standardized data set; and
converting the input based on the standardized data set.
